(19) United States
(12) Patent Application Publication
(10) Pub. No.: US 2018/0231829 A1
(43) Pub. Date: Aug. 16, 2018

(54) DISPLAY DEVICE

(71) Applicant: Japan Display Inc., Minato-ku (JP)

(72) Inventor: Osamu ITOU, Tokyo (JP)

(73) Assignee: Japan Display Inc., Minato-ku (JP)

(21) Appl. No.: 15/896,341

(22) Filed: Feb. 14, 2018

(30) Foreign Application Priority Data
Feb. 14, 2017 (JP) 2017-024972

(51) Int. Cl. G02F 1/1335; G02F 1/1333; G02F 1/1343

(52) U.S. Cl. CPC G02F 1/133514; G02F 1/1343; G02F 1/133345

(57) ABSTRACT

According to one embodiment, a display device including a first substrate including a first insulating film which has a first upper surface, a first video signal line, a first barrier film which is in contact with the first upper surface, covers the first video signal line, and has a second upper surface and side surfaces, a color filter which is in contact with the first upper surface and the side surfaces and has a third upper surface, and a second insulating film which is in contact with the second upper surface and the third upper surface and has a fourth upper surface, a second substrate, the fourth upper surface just above the color filter being located at an upper position than the second upper surface.

### CROSS-REFERENCE TO RELATED APPLICATIONS

This application is based upon and claims the benefit of priority from Japanese Patent Application No. 2017-024972, filed Feb. 14, 2017, the entire contents of which are incorporated herein by reference.

### FIELD

Embodiments described herein relate generally to a display device.

### BACKGROUND

Future expansion of the market of virtual reality (VR) viewers has been expected. Middle-size and small-size liquid crystal displays (LCDs) applied to VR are required to have much higher definition than those for smartphones. In accordance with this, solution of color mixture, reduction in size of a spacer, etc., are often required. In addition, expansion of color gamut on the display, and the like are required. Furthermore, in-cell touch panels corresponding to displays for both of smartphones and VR viewers, and the like are also required to be installed.

To satisfy these requirements, a display of Color Filter On Array (COA) type having a high aperture ratio is desired or further improvement of the aperture ratio is required.

### BRIEF DESCRIPTION OF THE DRAWINGS

FIG. 1 is a perspective view showing an example of an appearance of a liquid crystal display device.

FIG. 2 is a plan view of a first substrate.

FIG. 3 is a plan view showing a barrier film of a first substrate according to First Embodiment.

FIG. 4 is a plan view showing a second substrate according to the First Embodiment.

FIG. 5A is a view showing an example of a section of a display panel in line A-A′ in FIG. 2.

FIG. 5B is a view showing an example of a sectional shape of the barrier wall.

FIG. 5C is a view showing an example of the sectional shape of the barrier wall.

FIG. 6 is a cross-sectional view showing the display panel in line B-B′ in FIG. 2.

FIG. 7 is a cross-sectional view showing the display panel in line C-C′ in FIG. 2.

FIG. 8 is a cross-sectional view showing the display panel in line D-D′ in FIG. 2.

FIG. 9A is a cross-sectional view schematically showing a formed state of a color filter.

FIG. 9B is a cross-sectional view schematically showing the formed state of the color filter.

FIG. 9C is a cross-sectional view schematically showing the formed state of the color filter.

FIG. 10A is a cross-sectional view schematically showing the formed state of the color filter.

FIG. 10B is a cross-sectional view schematically showing the formed state of the color filter.

FIG. 10C is a cross-sectional view schematically showing the formed state of the color filter.

FIG. 11 is a plan view showing a barrier film of a first substrate according to Second Embodiment.

FIG. 12 is a plan view showing a second substrate according to the Second Embodiment.

### DETAILED DESCRIPTION

In general, according to one embodiment, a display device comprises: a first substrate comprising a first insulating film which has a first upper surface, a first video signal line which is in contact with the first upper surface, a first barrier film which is in contact with the first upper surface, covers the first video signal line, and has a second upper surface and side surfaces, a color filter which is in contact with the first upper surface and the side surfaces and has a third upper surface, and a second insulating film which is in contact with the second upper surface and the third upper surface and has a fourth upper surface; a second substrate opposed to the first substrate, the fourth upper surface just above the color filter being located at an upper position than the second upper surface.

According to another embodiment, a display device comprises: a first substrate comprising a first insulating film which has a first upper surface, a first base which is in contact with the first upper surface, a second base which is in contact with the first upper surface and separated from the first base, a video signal line which is in contact with the first upper surface, located between the first base and the second base, and electrically connected to the second base, a barrier film which is in contact with the first upper surface, covers the video signal line, the first base, and the second base, includes a first contact hole formed to penetrate to the first base, includes a second contact hole formed to penetrate to the second base, and has a first side surface and a second side surface, a first color filter which is in contact with the first side surface, and a second color filter which is in contact with the second side surface and has a color different from the color of the first color filter; and a second substrate opposed to the first substrate, the barrier film having a second upper surface between the first color filter and the second color filter, and having a first protruding portion which protrudes more upwardly than the second upper surface between the first contact hole and the second contact hole.

According to yet another embodiment, a display device comprises: a first substrate comprising a first insulating film which has a first upper surface, a video signal line which is in contact with the first upper surface, a barrier film which is in contact with the first upper surface and covers the video signal line, a color filter which is in contact with the first upper surface, a second insulating film which is in contact with the barrier film and the color filter, a first electrode which is located above the second insulating film, a common line which is located above the video signal line and the first electrode and which is in contact with the first electrode, and a light absorbing film which is located above the common line; and a second substrate opposed to the first substrate.

Embodiments will be described hereinafter with reference to the accompanying drawings. The disclosure is a mere example, and arbitrary change of gist which can be easily conceived by a person of ordinary skill in the art naturally falls within the inventive scope. To more clarify the explanations, the drawings may pictorially show width, thickness, shape and the like, of each portion as compared with an actual aspect, but they are mere examples and do not restrict the interpretation of the invention. In the present specification and drawings, elements like or similar to those in the already described drawings may be denoted by similar reference numbers and their detailed descriptions may be arbitrarily omitted.

In the embodiments, a display device is disclosed as an example of the electronic device. The display device can be used for, for example, various devices such as a virtual reality (VR) viewer, a smartphone, a tablet terminal, a mobile telephone terminal, a personal computer, a notebook computer, and a game console.

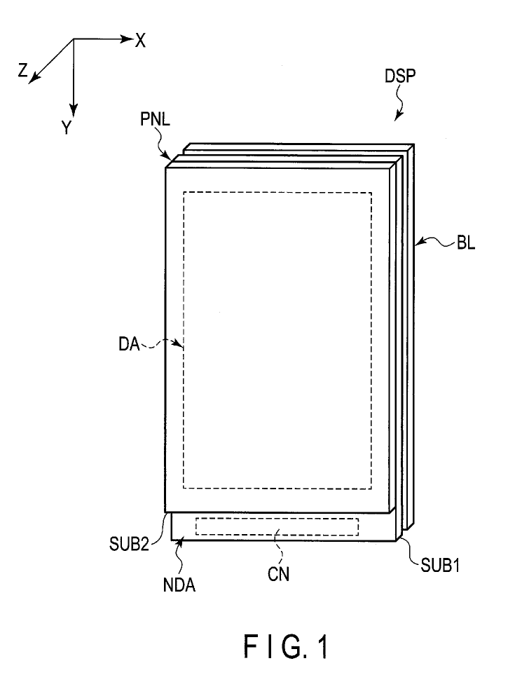

FIG. 1 is a perspective view showing an example of an appearance of a liquid crystal display device DSP. A first direction X, a second direction Y and a third direction Z are orthogonal to each other but may intersect at an angle other than 90 degrees. The first direction X and the second direction Y correspond to directions parallel to a main surface of a substrate constituting the liquid crystal display device (hereinafter simply called a display device) DSP, and the third direction Z corresponds to a thickness direction of the display device DSP. A plan view of the display device DSP in an X-Y plane defined by the first direction X and the second direction Y is illustrated here. Seeing the X-Y plane from the third direction Z is defined as planar view in the following explanations.

The display device DSP comprises a display panel PNL and an illumination device BL.

The display panel PNL includes a first substrate SUB1, a second substrate SUB2, and a liquid crystal layer (a liquid crystal layer LC explained later) held between the first substrate SUB1 and the second substrate SUB2. The display panel PNL includes a display area DA and a non-display area NDA. The display area DA is an area for displaying an image. The display area DA is located substantially in the center of the area where the first substrate SUB1 and the second substrate SUB2 are opposed to each other. The non-display area NDA is an area in which no images are displayed, and is located outside the display area DA.

The first substrate SUB1 includes a connection module CN. The connection module CN comprises a terminal for connection of signal supply sources such as a flexible printed circuit and an IC chip. The connection module CN is located in the non-display area NDA.

The illumination device BL is disposed on a back surface side of the first substrate SUB1 (i.e., a side opposite to a surface opposed to the second substrate SUB2). Various types of devices are applicable as the illumination device BL. For example, the illumination device BL comprises a light guide opposed to the first substrate SUB1, light sources such as light-emitting diodes (LEDs) disposed along an end portion of the light guide, a reflective sheet disposed on one of main surface sides of the light guide, various optical sheets deposited on the other main surface side of the light guide, and the like. The light source emits, for example, white light.

The display panel PNL in the example illustrated is a transmissive display panel which displays an image by allowing the light from the illumination device BL to be transmitted selectively, but is not limited to this. For example, the display panel PNL may be a reflective display panel which allows an image to be displayed by urging external light or the light from an external light source to be selectively transmitted, or a transflective display panel having display functions of both the transmissive display panel and the reflective display panel.

The detailed configuration of the display panel PNL is not explained here but, any one of a display mode using a longitudinal electric field along a normal of the display panel PNL, a display mode using an oblique electric field which is angled to the normal of the display panel PNL, and a display mode using a lateral electric field along the main surface of the display panel PNL can be applied to the display panel PNL.

In each of the embodiments hereinafter explained, a direction from the first substrate SUB1 to the second substrate SUB2 is called an upward direction (or, more simply, upwardly) and a direction from the second substrate SUB2 to the first substrate SUB1 is called a downward direction (or, more simply, downwardly).

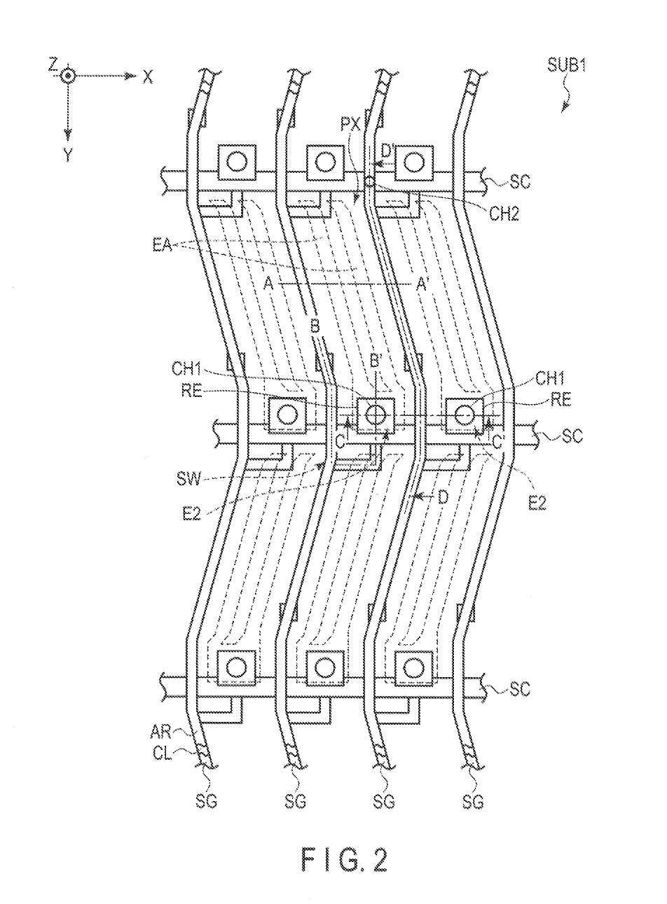

FIG. 2 is a plan view of the first substrate SUB1. Main portions of the first substrate SUB1 are shown in FIG. 2. A configuration example using a fringe field switching (FFS) mode which is one of the display modes using the lateral electric field will be hereinafter explained.

The first substrate SUB1 includes scanning signal lines SC, video signal lines SG, switching elements SW, base layers RE, first electrodes E1, second electrodes E2, common lines CL, light absorbing films AR, and the like. In FIG. 2, only constituent elements necessary for explanations are illustrated, but illustration of the first electrodes E1 and the like is omitted.

The scanning signal lines SC are arranged in the second direction Y and spaced apart from each other at regular intervals. Each of the scanning signal lines SC extends in the first direction X and is shaped in a straight line. The scanning signal line SC is, for example, a molybdenum tungsten alloy film. The scanning signal lines SC may be bent partially. The video signal lines SG are arranged in the first direction X and spaced apart from each other with at regular intervals. Each of the video signal lines SG extends substantially in the second direction Y and is bent partially. In the example illustrated, the video signal lines SG located between two adjacent scanning signal lines SC extend in a direction different from the first direction X and the second direction Y. The video signal line SG is, for example, a three-layer laminated film of titanium, aluminum, and titanium, a three-layer laminated film formed by depositing molybdenum, aluminum, and molybdenum, or the like. The video signal line SG may be formed in a straight line along the second direction Y. In the drawing, each pixel PX corresponds to an area sectioned by two adjacent scanning signal lines SC and two adjacent video signal lines SG.

The switching elements SW are electrically connected to the scanning signal lines SC and the video signal lines SG. Details of the switching elements SW will be described later. The base layers RE are electrically connected to the switching elements SW. The base layer RE is, for example, a three-layer laminated film of titanium, aluminum, and titanium, a three-layer laminated film formed by depositing molybdenum, aluminum, and molybdenum, or the like. The first electrode E1 is a common electrode disposed across the pixels PX. The first electrode E1 is formed in a substantially flat plane and a common potential is applied to the first electrode E1. As represented in the drawing by a dotted line, the second electrode E2 is a pixel electrode disposed in each of the pixels PX. The second electrode E2 is electrically connected to the base layer RE. In the example illustrated, the second electrode E2 includes two strip electrodes EA to which an electric potential corresponding to the image signal is applied. The strip electrodes EA extend substantially parallel to the video signal lines SG. In the drawing, CH1 denotes a contact hole for electric connection between the base layer RE and the second electrode E2. In addition, in the drawing, CH2 denotes a contact hole for electric connection between the common line CL and the first electrode E1. In planar view, the contact hole CH2 is located at a portion where the scanning signal line SC and the video signal line SG intersect. The contact hole CH2 may be formed in the non-display area NDA of the array substrate SUB1.

The common lines CL are disposed along the video signal lines SG. In the example illustrated, the common lines CL overlap the video signal lines SG in planar view. The light absorbing films AR overlap the common lines CL in planar view. The second electrodes E2 are spaced apart from the common lines CL and the line absorbing films AR in planar view. The common line CL is, for example, a three-layer stacked film of a molybdenum tungsten alloy, aluminum, and a molybdenum tungsten alloy.

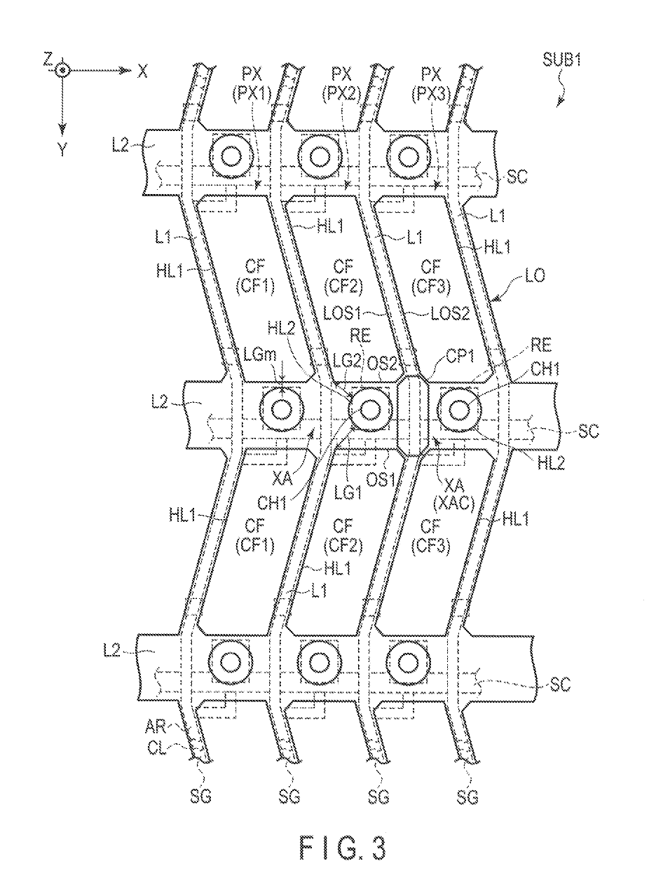

FIG. 3 is a plan view showing a barrier film LO of the first substrate SUB1 according to the First Embodiment. Main portions of the first substrate SUB1 shown in FIG. 2 are represented by dotted lines.

The first substrate SUB1 includes the barrier film LO, color filters CF, and the like. The barrier film LO is formed of a positive photoresist of a transparent resin material, for example, a transparent organic material. The barrier film LO may be formed of a black resin material or the like. The barrier film LO is formed in a grating shape in the X-Y plane. In the example illustrated, the barrier film LO includes a plurality of first portions L1 extending along the video signal lines SG and spaced apart from each other in the first direction X, and a plurality of second portions L2 extending along the scanning signal lines SC and spaced apart from each other in the second direction Y. In the barrier film LO, the width of the second portion L2 in the second direction Y is larger than the width of the first portion L1 in the first direction X. For example, the first portion L1 of the barrier film LO is wider than the video signal line SG in the first direction X and is formed to be so wide as to cover the entire body of the video signal line SG in planar view. In contrast, the second portion L2 of the barrier film LO is wider than the scanning signal line SC and the base layer RE in the second direction Y and is formed to be so wide as to cover the entire bodies of the scanning signal line SC and the base layer RE in planar view. The barrier film LO includes an intersection XA where the first portion L1 and the second portion L2 intersect. In the barrier film LO, a plurality of first hole portions HL1 and a plurality of second hole portions HL2 are formed. In the example illustrated, the first hole portion HL1 corresponds to an area surrounded by the first portions L1 and the second portions L2, and is formed in a substantially square shape. The second hole portion HL2 is located on the base layer RE and formed in a circular shape. In the example illustrated, the second portion L2 includes a first side surface OS1 and a second side surface OS2. Each of the first side surface OS1 and the second side surface OS2 extends in the first direction X. LG1 indicates a distance between the first hole portion HL1 and the second hole portion HL2 on the first side surface OAl side, and LG2 indicates a distance between the first hole portion HL1 and the second hole portion HL2 on the second side surface OS1 side. The shortest distance LGm of the distance LG1 and the distance LG2 is, for example, 2 μm. The shortest distance is a distance for preventing the color filters CF applied to the second hole portions HL2 from flowing to the first hole portions HL1. The contact holes CH1 are formed inside the second hole portions HL2.

In addition, the barrier film LO comprises first protruding portions CP1 at several intersections XAC of the intersections XA. In the example illustrated, the first protruding portion CP1 is located on the second portion L2 between two adjacent second hole portions HL2 (contact holes CH1) and is formed in an approximately rectangular shape extending in the second direction Y along the video signal lines SG. The barrier film LO also comprises another first protruding portion CP1 though not illustrated in the drawing. For example, two video signal lines SG and one scanning signal line SC are located between two first protruding portions CP1 but are not limited to this arrangement example.

The color filters CF are located inside the first hole portions HL1 formed in the barrier film LO. The color filters CF are formed of, for example, a negative photoresist containing pigment. The color filters CF include, for example, a green color filter CF1, a blue color filter CF2, and a red color filter CF3. The color filter CF1 is formed of a green-colored resin substance, for example, a negative photoresist containing green pigment. The color filters CF1 are disposed in several pixels PX1 of the pixels PX displaying a green color. The color filter CF2 is formed of a blue-colored resin substance, for example, a negative photoresist containing green pigment. The color filters CF2 are disposed in several pixels PX2 of the pixels PX displaying a blue color. The color filter CF3 is formed of a red-colored resin substance, for example, a negative photoresist containing red pigment. The color filters CF3 are disposed in several pixels PX3 of the pixels PX displaying a red color. The color filters CF are aligned to display different colors while the first portions L1 of the barrier film LO are interposed between the color filters CF. In the example illustrated, the color filters CF1, CF2, and CF3 are disposed repeatedly and cyclically in the first direction X while the first portions L1 of the barrier film LO are interposed between the color filters CF. For example, the color filter CF2 is located on a first side surface LOS1 side of the first portion L1 connected to the first protruding portion CP1, and the color filter CF3 is located on a second side surface LOS2 side of the first portion L1.

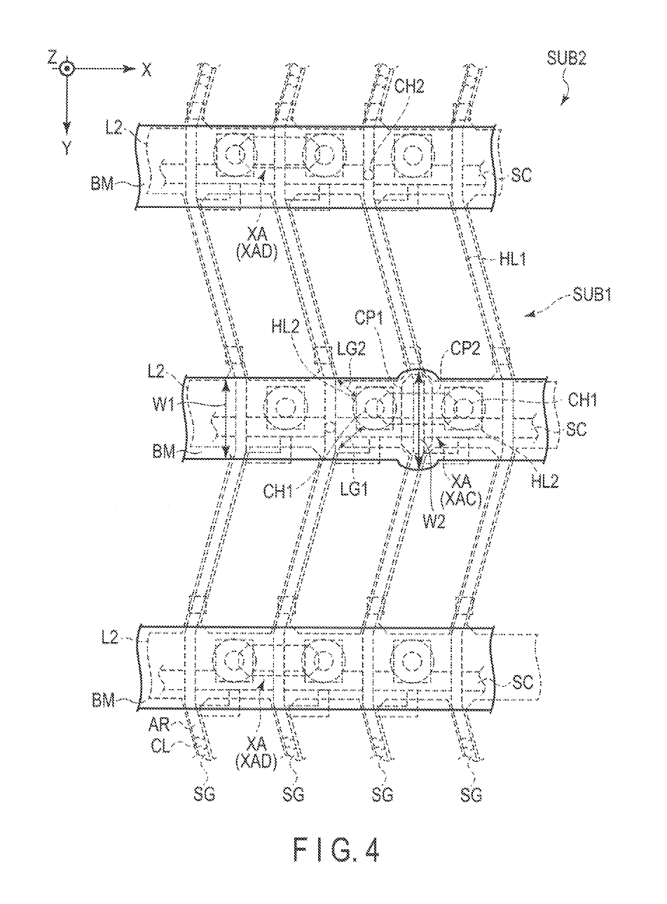

FIG. 4 is a plan view showing the second substrate SUB2 according to the First Embodiment. The back surface side of the second substrate SUB2 (i.e., the surface opposed to the first substrate SUB1) and the major portions of the first substrate SUB1 shown in FIG. 2 are represented by dotted lines.

The second substrate SUB2 includes a light-shielding layer BM, a second protruding portion CP2, and the like. The light-shielding layer BM is formed of, for example, a negative photoresist containing black pigment. In planar view, the light-shielding layer BM overlaps the scanning signal line SC, the base layers RE, the second hole portions HL2 (contact holes CH1), and the like. In contrast, the light-shielding layer BM does not overlap the video signal lines SG at a position between two adjacent scanning signal lines SC. In planar view, a portion of the light-shielding layer BM which overlaps the first protruding portion CP1 is formed to be wider than its peripheral portion. In the example illustrated, the light-shielding layer BM extends in the first direction X with a width W1 along the second direction Y, to block light transmitted from parts of a corner of the first hole portion HL1. The light-shielding layer BM is expanded with a width W2 larger in the second direction Y, than the width W1, at a portion which overlaps the first protruding portion CP1.

In planar view, the second protruding portion CP2 is located on the back surface side of the second substrate SUB2 and formed in an appropriately rectangular shape elongated in the first direction X. In the example illustrated, the second protruding portion CP2 extends parallel to the scanning signal line SC in the first direction X, from one of two adjacent second hole portions HL2 (contact holes CH1) to the other. In planar view, the second protruding portion CP2 located on the intersection XAC orthogonally intersects the first protruding portion CP1. In addition, in the example illustrated, two second protruding portions CP2 located on several intersections XAD of the intersections XA are shown. The first protruding portion CP1 is not located on the intersection XAD. In other words, the second protruding portion CP2 located on the intersection XAD does not overlap the first protruding portion CP1, in planar view. A second spacer portion XP2 is formed at a portion at which the second protruding portion CP2 is located, as explained later in detail. The second spacer portion XP2 formed on the intersection XAD contacts a configuration of the opposed first substrate SUB1 and holds the liquid crystal layer LC when the volume of the liquid crystal layer LC is reduced and the thickness of the liquid crystal layer LC is also reduced at a low temperature.

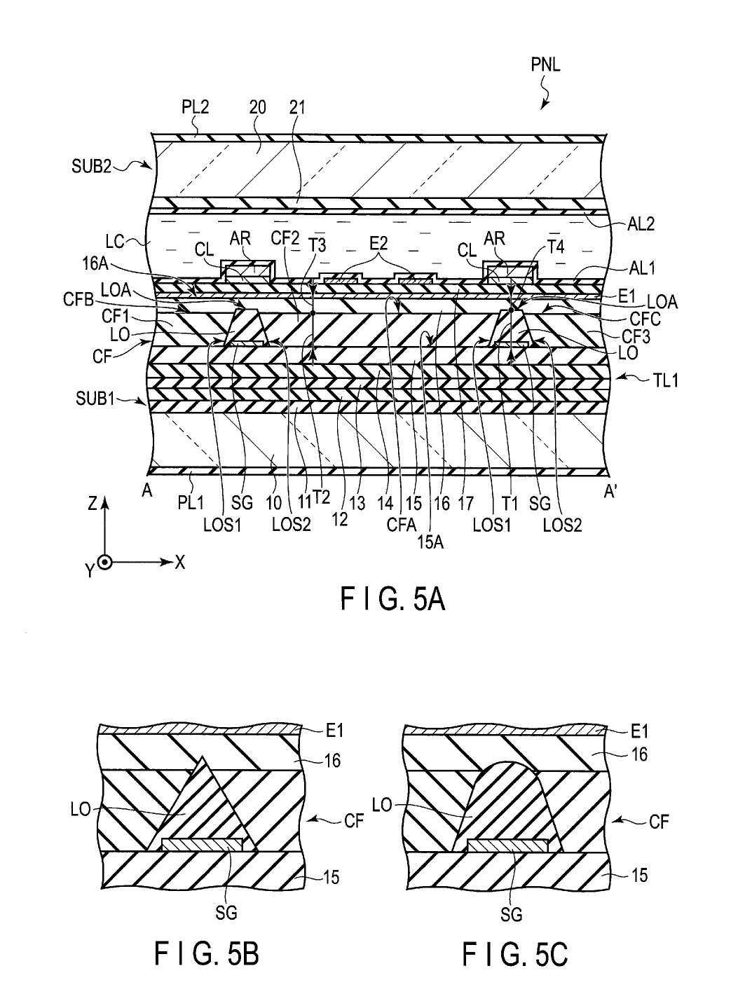

FIG. 5A is a view showing an example of a section of the display panel PNL in line A-A′ in FIG. 2, and FIG. 5B and FIG. 5C are views showing an example of a sectional shape of the barrier film LO.

The first substrate SUB1 includes a support substrate 10, insulating films 11, 12, 13, 14, 15, 16, and 17, the video signal line SG, the barrier film LO, the color filter CF, the first electrode E1, the second electrodes E2, the common lines CL, the light absorbing film AR, an alignment film AL1 and the like. A polarizer PL1 is disposed under the support substrate 10. The insulating films 11 to 17 may be expressed as interlayer insulating films.

The support substrate 10 is transparent and is formed of, for example, glass such as borosilicate glass, but may be formed of resin such as plastic. In addition, the material is not limited to the plastic but the support substrate 10 may be a flexible substrate having flexibility. The insulating films 11 to 17 are transparent. The insulating films 11 to 15 and 17 are inorganic insulating layers and are formed of, for example, silicon nitride or silicon oxide. The insulating film 16 is an organic insulating film and is formed of, for example, resin such as acrylic resin. For example, the insulating film 16 is a positive photoresist of a transparent organic material. The insulating film 16 may be formed of the same substance as the barrier film LO.

The insulating film 11 is located on the support substrate 10 and is in contact with the support substrate 10. The insulating film 12 is located on the insulating film 11 and is in contact with the insulating film 11. The insulating film 13 is located on the insulating film 12 and is in contact with the insulating film 12. The insulating film 14 is located on the insulating film 13 and is in contact with the insulating film 13. The insulating film 15 is located on the insulating film 14 and is in contact with the insulating film 14. All the insulating films 11 to 15 may be called an insulating film (first insulating film) IL1.

The video signal line SG is located on the insulating film 15 and is in contact with the insulating film 15.

The barrier film LO is located on the insulating film 15 and the video signal line SG and is in contact with the insulating film 15 and the video signal line SG, and covers the video signal line SG. The barrier film LO has an upper surface LOA. In the example illustrated, the barrier film LO has a cross-section of a tapered (hereinafter called forward taper) shape in which the width becomes smaller toward the upper side in the first direction X. For this reason, the cross-section of the barrier film LO is formed in a trapezoidal shape in which a lower surface in contact with the insulating film 15 and the video signal line SG is called a lower bottom and the upper surface LOA is called an upper bottom. As shown in FIG. 5B, the barrier film LO may have a triangular cross-section which does not have the upper surface LOA and in which side surfaces LOS1 and LOS2 intersect at an upper position. In addition, the barrier film LO may have a cross-section curved in a semi-circular shape at an upper position as shown in FIG. 5C, as the other cross-section of the barrier film LO. In the example shown in FIG. 5A to 5C, the width of the lower bottom of the barrier film LO in the first direction X is larger than the width of the video signal line SG in the first direction X. In contrast, the width of the upper bottom (upper part) of the barrier film LO in the first direction X is smaller than the width of the video signal line SG in the first direction X.

The color filter CF is located on the insulating film 15 and is in contact with the insulating film 15, similarly to the barrier film LO. The color filter CF is partitioned by the barrier film LO. In the example illustrated, an upper surface CFA of the color filter CF2 is located at a lower position than the upper surface LOA of the barrier film LO, in the third direction Z. The insulating film 15 includes an upper surface 15A. The thickness (hereinafter also called the thickness of the barrier film LO) T1 between the upper surface 15A and the upper surface LOA of the barrier film LO is larger than the thickness (hereinafter also called the thickness of the color filter CF1) T2 between the upper surface 15A and the upper surface CFA of the color filter CF2. In the example illustrated, the thickness of the color filter CF1 between the upper surface 15A and an upper surface CFB of the color filter CF1 and the thickness of the color filter CF3 between the upper surface 15A and an upper surface CFC of the color filter CF3 are approximately equal to the thickness of the color filter CF1. Each of the thickness of the color filter CF1 between the upper surface 15A and an upper surface CFB of the color filter CF1 and the thickness of the color filter CF3 between the upper surface 15A and an upper surface CFC of the color filter CF3 may be substantially different from the thickness of the color filter CF1. The thickness T2 is often called the thickness of the color filter CF. In addition, the thickness T1 often indicates the thickness between the upper surface 15A and a top of the barrier film LO. A part of the color filter CF may be in contact with the upper surface LOA of the barrier film LO but, in the example illustrated, color filter CF2 is not in contact with the upper surface LOA of any one of the barrier films LO located on both sides of the color filter CF2. More specifically, the color filter CF1 located on the left side of the figure is in contact with the side surface LOST of the adjacent barrier film LO but is not in contact with the upper surface LOA of the barrier film LO. In other words, none of adjacent color filters CF1 and CF2 exists on the upper surface LOA of the left barrier film LO, of two barrier films LO shown in the figure. Similarly, none of adjacent color filters CF2 and CF3 exists on the upper surface LOA of the right barrier film LO shown in the figure. However, at least one of the color filters CF1 to CF3 may be in contact with the upper surface LOA of either of the barrier films LO.

The insulating film 16 is in contact with not only the upper surface CFA of the color filter CF2 but upper surface CFB of the color filter CF1 and the upper surface CFC of the color filter CF3, and is also in contact with the upper surfaces LOA of the barrier films LO. The insulating film 16 includes an upper surface 16A. The upper surface 16A is located at an upper position than the upper surfaces CFA, CFB, and CFC and the upper surfaces LOA. The thickness (hereinafter also called first thickness of the insulating film 16) T3 of the insulating film 16 between the upper surface CFA and the upper surface 16A is larger than the thickness (hereinafter also called second thickness of the insulating film 16) T4 between the upper surface LOA and the upper surface 16A. In the example illustrated, the thickness of the insulating film 16 between the upper surface CFB and the upper surface 16A and the thickness of the insulating film 16 between the upper surface CFC and the upper surface 16A are approximately equal to the first thickness T3 of the insulating film 16. The insulating film 16 planarizes the unevenness generated by the color filter CF and the barrier film LO. In other words, the sum of the thickness T2 and the first thickness T3 is approximately equal to the sum of the thickness T1 and the second thickness T4.

The first electrode E1 is located on the insulating film 16 and is in contact with the insulating film 16. The first electrode E1 extends across the pixels. In the example illustrated, the first electrode E1 extends just above the color filters CF1 to CF3 without being cut just above the video signal lines SG. The first electrode E1 is formed of, for example, a transparent conductive material such as indium tin oxide (ITO), indium zinc oxide (IZO) or indium gallium oxide (IGO).

An insulating layer 17 is located on the first electrode E1 and is in contact with the first electrode E1.

The common line CL is in contact with the insulating film 17 at a position just above the video signal line SG. In the example illustrated, the common line CL is located on the insulating film 17. The common line CL is, for example, a metallic three-layer stacked film formed of a molybdenum tungsten alloy, aluminum, and a molybdenum tungsten alloy. The common line CL has a thickness of, for example, approximately 200 nm. Such a common line CL is connected to the first electrode E1 via the above-explained contact hole CH2 and supplies a common potential to the first electrode E1. The electric potential of the first electrode E1 may be kept constant, but may be varied together with a scanning cycle for the purpose of reduction of flicker or the like. If the electric potential of the first electrode E1 is varied, the potential variation is often delayed solely since the first electrode E1 is highly resistive as compared with the metal lines. By urging the common lines CL and the first electrode E1 to be connected to each other through the contact hole CH2, the resistance of the first electrode E1 can be reduced and the delay in potential variation can be suppressed. The width of the common line CL in the first direction X is larger than or equal to the width of the video signal line SG in the first direction X. In addition, for example, the common line CL may be located between an insulating film 17 and the first electrode E1 and may be in contact with the first electrode E1.

The light absorbing film AR is located on the common line CL just above the video signal line SG and is in contact with the common line CL. The light absorbing film AR is, for example, a negative photoresist containing black pigment. The width of the light absorbing film AR in the first direction X is larger than or equal to the width of the common line CL in the first direction X. To suppress the reflection on the sides of the video signal line SG or the sides of the common line CL, the width of the light absorbing film AR should desirably be larger than the width of the video signal line SG in the first direction X and the width of the common line CL in the first direction X.

The second electrode E2 is located on the insulating film 17 and is in contact with the insulating film 17. The second electrode E2 is disposed in each pixel. The second electrodes E2 are spaced apart from the common lines CL, the line absorbing films AR, and the like. The second electrode E2 is formed of, for example, a transparent conductive material such as ITO, IZO or IGO.

The alignment film AL1 covers the common line CL, the light absorbing film AR, the insulating film 17, and the second electrode E2. The alignment film AL1 is a polyimide film having an optical alignment property. In addition, the alignment film AL1 may be a polyimide film subjected to rubbing.

The liquid crystal layer LC is located on the first substrate SUB1. The liquid crystal layer LC may be in a positive type having a positive dielectric anisotropy or a negative type having a negative dielectric anisotropy.

The second substrate SUB2 is located on the liquid crystal layer LC. The second substrate SUB2 includes a support substrate 20, an insulating film 21, an alignment film AL2, and the like.

A polarizer PL2 is disposed above the support substrate 20. Absorption axes of the polarizer PL1 and the polarizer PL2 are set to be orthogonal to each other in planar view. The absorption axis of the polarizer PL2 is parallel to the alignment direction of the liquid crystal layer LC. For this reason, the display device DSP can obtain normally black type voltage-luminance property by the axial arrangement of the polarizer PL1, the polarizer PL2, and the liquid crystal layer LC. According to the normally black type voltage-luminance property, the display device DSP makes dark display when no voltage is applied to the liquid crystal layer LC and makes bright display when a voltage is applied to the liquid crystal layer LC.

The support substrate 20 is transparent and is formed of, for example, glass such as borosilicate glass, but may be formed of resin such as plastic. The insulating film 21 is located under the support substrate 20 and is in contact with the support substrate 20. The insulating film 21 is a transparent organic insulating film, which is formed of, for example, resin such as acrylic resin. The alignment film AL2 is located under the insulating film 21 and is in contact with the insulating film 21, and covers the insulating film 21. The alignment film AL2 is a polyimide film having an optical alignment property. The second substrate SUB2 has a transparent area which allows the light to be transmitted toward the upper side of the video signal line SG. In other words, a light-shielding layer is not disposed above the video signal line SG, in the second substrate SUB2.

The display device DSP is designed to be the Color Filter on Array (COA) type in which the color filter CF is disposed on the same substrate as the active element, and the COA type has an effect of reducing color mixture. The color mixture is a phenomenon peculiar to the display device of FFS type capable of displaying chromatically pure colors and, when the orientation of observation is observed as a direction parallel to the repetitive alignment of the color filter CF while varying the polar angle within the range including the normal, the color chromaticity seems to be varied largely on its either side of the direction. In the display device DSP, the pixels PX and the color filters CF are disposed to have one-on-one correspondence. The color mixture occurs due to the light passing through the pixels PX and the color filters CF which do not correspond to each other. A path of such light becomes apparent when the displacement between the color filters CF and the pixels PX and the interval between the color filters CF and the pixels PX increase at a proportion in high-definition pixel which cannot be neglected, to the width of the pixel PX. The displacement between the color filters CF and the pixels PX can be reduced and the interval between the color filters CF and the pixels PX can also be reduced by forming the color filters CF on the array substrate. For this reason, the display device DSP of the COA type can reduce the color mixture.

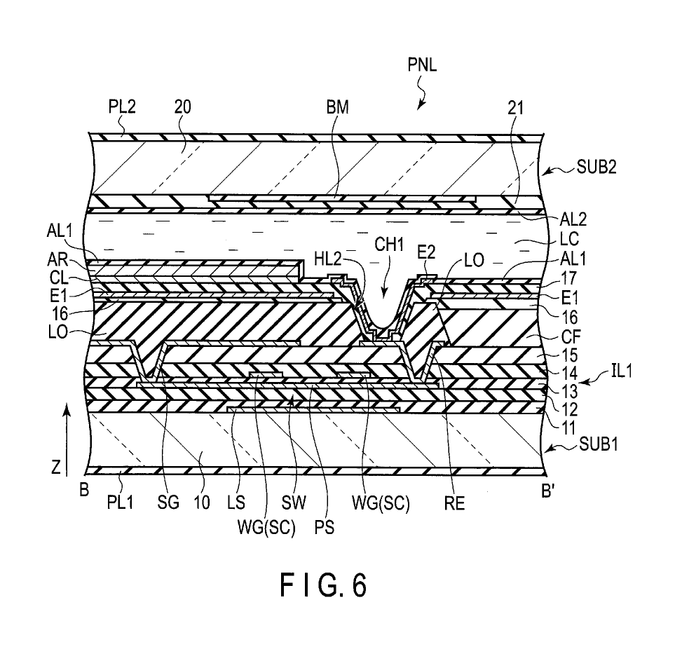

FIG. 6 is a cross-sectional view showing the display panel PNL in line B-B′ of FIG. 2. Portions different from those shown in the cross-sectional views of FIG. 5A to FIG. 5C will be mainly explained here.

The first substrate SUB1 includes a light-shielding layer LS, the switching element SW, base layer RE, and the like. The light-shielding layer LS is located between the support substrate 10 and the insulating layer 11 and is in contact with an upper surface of the support substrate 10. The light-shielding layer LS is formed of, for example, a molybdenum tungsten alloy. The switching element SW comprises a semiconductor layer PS. The semiconductor layer PS is located between the insulating film 12 and the insulating film 13 and is in contact with an upper surface of the insulating film 12. The semiconductor layer PS is formed of, for example, polycrystalline silicon. Two gate electrodes WG serving as parts of the scanning signal line SC are located between the insulating layer 13 and the insulating layer 14 and are in contact with an upper surface of the insulating film 13. The scanning signal line SC is formed of, for example, a molybdenum tungsten alloy. Each of the video signal line SG and the base layer RE is located between the insulating film 15 and the barrier film LO and is in contact with the upper surface of the insulating film 15. Each of the video signal line SG and the base layer RE penetrates the insulating films 13 to 15 and are in contact with the upper surface of the semiconductor layer PS. The video signal line SG and the base layer RE are formed of, for example, a metal formed by stacking molybdenum, aluminum, and molybdenum in order or a metal formed by stacking titanium, aluminum, and titanium in order. The second electrode E2 extends to the contact hole CH1 and is in contact with an upper surface of the relay electrode

RE.

The second substrate SUB2 includes a light-shielding layer BM, and the like. The light-shielding layer BM is located above the gate electrodes WG and the contact hole CH1 and between the support substrate 20 and the insulating film 21.

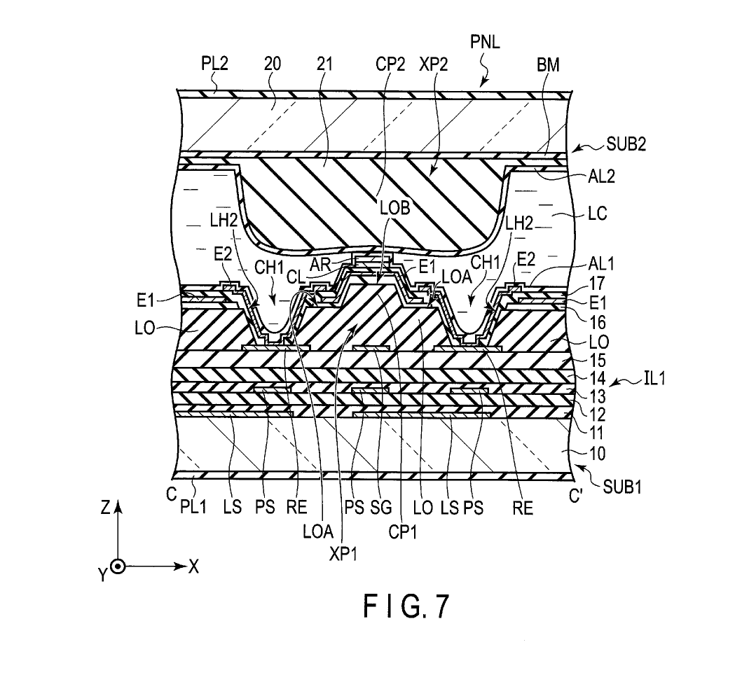

FIG. 7 is a cross-sectional view showing the display panel PNL in line C-C′ of FIG. 2. Portions different from those shown in the cross-sectional views of FIG. 5A to FIG. 5C and FIG. 6 will be mainly explained here.

The first substrate SUB1 includes a first spacer portion XP1, and the like. The first spacer portion XP1 is formed by stacking video signal line SG, the barrier film LO, the insulating film 16, the first electrode E1, the insulating film 17, the common line CL, the light absorbing film AR, and the alignment film AL1 in order in the third direction Z. The first spacer portion XP1 is located between two adjacent contact holes CH1 in the first direction X. The first spacer portion XP1 includes step portions and protrudes upwardly at a position just above the video signal line SG. The thickness of the first spacer portion XP1 is mainly determined by the thickness of the barrier film LO. In other words, the steps of the first spacer portion XP1 are formed by steps of the barrier film LO.

On the first spacer portion XP1, the barrier film LO includes a first protruding portion CP1 which protrudes more upwardly than the peripheral portions, at a position just above the video signal line SG. The first protruding portion CP1 has a cross-section of a forward tapered shape which is narrowed upwardly from the upper surface LOA of the surrounding barrier film LO. In the example illustrated, the first protruding portion CP1 comprises an upper surface LOB which is located at an upper position than the upper surface LOA of the surrounding barrier film LO. The steps of the barrier film LO are formed by the difference in position between the upper surfaces LOA and LOB. The insulating film 16, the first electrode E1, the insulating film 17, and the alignment film AL1 are disposed over the upper surface LOA and the upper surface LOB. The common line CL and the light absorbing film AR are disposed above the upper surface LOB alone and are not disposed above the upper surface LOA, on the first spacer portion XP1.

The second substrate SUB2 includes the second spacer portion XP2, and the like. The second spacer portion XP2 includes the insulating film 21 and the alignment film AL2. The second spacer portion XP2 protrudes downwardly to the first spacer portion XP1. In the example illustrated, the second spacer portion XP2 is located between two adjacent contact holes CH1 in the first direction X. The thickness of the second spacer portion XP2 is mainly determined by the thickness of the second protruding portion CP2.

The first spacer portion XP1 and the second spacer portion XP2 are in contact with each other. The first spacer portion XP1 and the second spacer portion XP2 form a spacer for holding a gap between the first substrate SUB1 and the second substrate SUB2.

If the thickness of the cross-section of the barrier film LO is sufficiently large and the upper surface of the barrier film LO is planarized, the first spacer portion XP1 and the second spacer portion XP2 can contact in a sufficient contact area. Therefore, even if the area of the first spacer portion XP1 and the second spacer portion XP2 is small in planar view, the first spacer portion XP1 and the second spacer portion XP2 can hold a gap.

In addition, the direction of extension (for example, the second direction Y) of the first spacer portion XP1 intersects the direction of extension (for example, the first direction X) of the second spacer portion XP2. For this reason, even if an external pressure is applied to the display device DSP and a force which causes displacement in any direction in the X-Y plane acts between the first substrate SUB1 and the second substrate SUB2, separation of the first spacer portion XP1 and the second spacer portion XP2 can be suppressed. In other words, even if a force acts in the first direction X, the displacement of the second substrate SUB2 can be permitted by the length of the second spacer portion XP2 in the first direction X and, similarly, even if a force acts in the second direction Y, the displacement of the first substrate SUB1 can be permitted by the length of the first spacer portion XP1 in the second direction Y.

In addition, even if an abrasion portion occurs at a contact portion between the first spacer portion XP1 and the second spacer portion XP2 due to the displacement between the first substrate SUB1 and the second substrate SUB2, alignment failure of the liquid crystal molecules in the pixel can be suppressed since the abrasion portion does not damage the alignment film in the pixel which contributes to the display. For this reason, light leakage which results from alignment failure in the vicinity of the spacer can be suppressed. Therefore, the installation area of the light-shielding layer which should be disposed in the surrounding of the spacer can be reduced and the aperture ratio of each pixel can be improved as compared with a structure of bringing a columnar spacer provided on one of the substrates into contact with the other substrate and holding a gap.

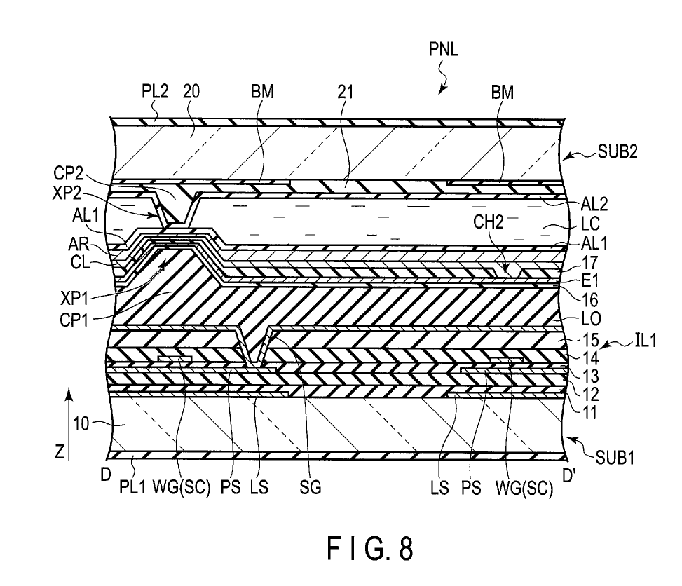

FIG. 8 is a cross-sectional view showing the display panel PNL in line D-D′ of FIG. 2. Portions different from those shown in the cross-sectional views of FIG. 5A to FIG. 5C, FIG. 6, and FIG. 7 will be mainly explained here.

In the insulating film 17, a contact hole CH2 which penetrates to the first electrode E1 is formed. The common line CL is in contact with the first electrode E1 via the contact hole CH2. The common line CL and the first electrode E1 are electrically connected to each other through a plurality of contact holes CH2, at a plurality of portions in the display area DA, though not illustrated in the drawing.

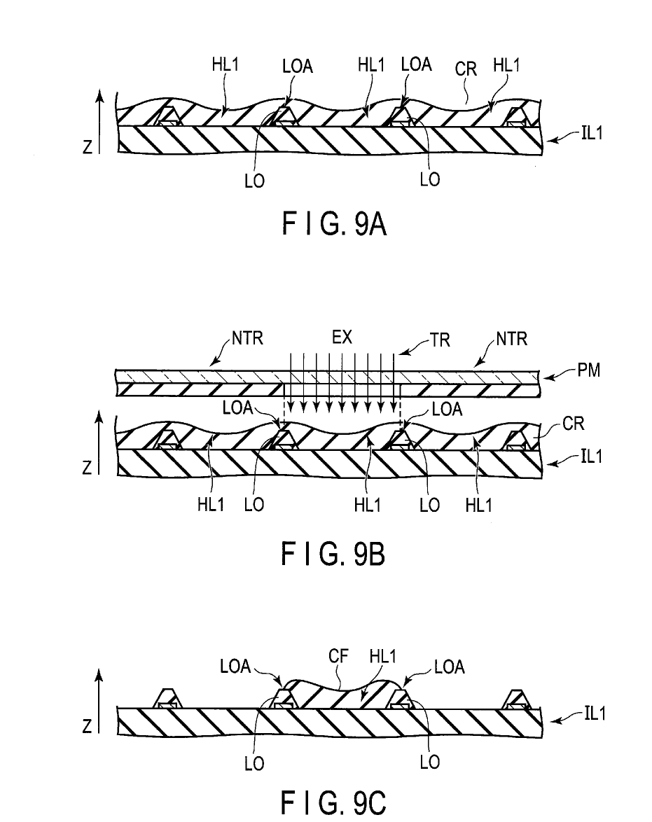

FIG. 9A, FIG. 9B, and FIG. 9C are cross-sectional views showing states of formation the color filter CF. To simplify the explanations, FIG. 9A to FIG. 9C show the barrier film LO and the color resist CR alone on an insulating film IL1. The color resist CR is formed of, for example, a negative photoresist containing pigment. In addition, photomask PM is, for example, a binary mask. The photomask PM comprises a transmissive portion TR which allows light EX to be transmitted and a non-transmissive portion NTR which does not allow the light EX to be transmitted.

FIG. 9A is a view showing an example of a state in which the color resist CR is applied on the insulating film IL1 comprising the barrier film LO. The color resist CR is applied on the insulating film IL1 and the barrier film LO. In the application, the color resist CR is fluid since the color resist CR contains a solvent. For this reason, the color resist CR is applied on the first hole portion HL1 to have large thickness and applied on the barrier film LO to have smaller thinness than the first hole portion HL1.

FIG. 9B is a view showing a state of exposing the color resist CR shown in FIG. 9A. The color resist CR located between two adjacent barrier films LO is exposed by using the photomask PM. The transmissive portion TR of the photomask PM is accurately located at an area between two adjacent barrier films LO, i.e., the first hole portion HL1. At this time, both ends of the transmissive portion TR of the photomask PM are located above the upper surfaces LOA of the barrier films LO, respectively. The light EX is emitted from the transmissive portion TR of the photomask PM to the color resist CR.

FIG. 9C is a view showing an example of a state in which the color resist CR shown in FIG. 9B is exposed and the color filter CF is formed on the insulating film IL1. As shown in FIG. 9C, the boundary of the color filter CF is located on the upper surfaces LOA of the barrier films LO. At this time, the color resist CR in contact with the upper surfaces LOA of the barrier films LO can be exposed up to its lower portion since the color resist CR is thin. For this reason, the color resist CR in contact with the upper surfaces LOA of the barrier films LO is cured sufficiently. The color resist CR in contact with the upper surfaces LOA of the barrier films LO can be therefore processed with high accuracy. In addition, since the barrier films LO are formed of the same organic substance as the color filter CF, the barrier films LO have good adhesion to the color filter CF. The color filter CF can hardly be peeled off from the barrier films LO.

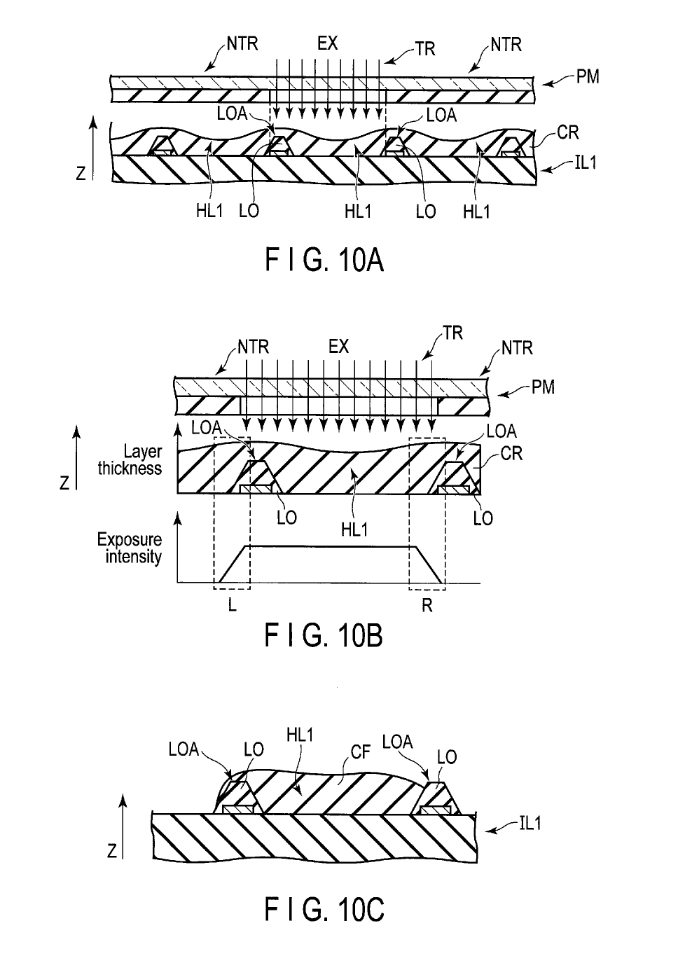

FIG. 10A, FIG. 10B, and FIG. 10C are cross-sectional views showing an example of a state of formation of the color filter CF.

FIG. 10A is a view showing a state of exposing the color resist CR shown in FIG. 9A by the photomask PM. The transmissive portion TR of the photomask PM is displaced from the first hole portion HL1. In the example illustrated, both ends of the transmissive portion TR of the photomask PM are displaced from the upper surfaces LOA of the barrier films LO. For example, both ends of the transmissive portion TR of the photomask PM are located at portions having sections of a forward tapered shape, of the barrier films LO. For this reason, the light EX is emitted from the transmissive portion TR of the photomask PM having the ends displaced from the upper surfaces LOA to the color resist CR.

FIG. 10B is a view showing an example of a relationship between the thickness and the exposure amount, of the color resist CR shown in FIG. 10A. As shown in the upper part of FIG. 10B, the light EX is emitted from the transmissive portion TR of the photomask PM having one end located on an area L and the other end located on the area R to the color resist CR. As shown in an exposure amount distribution illustrated at the lower part of FIG. 10B, even if the photomask PM is a binary mask, the exposure amount is continuously varied in accordance with the thickness of the color resist CR at the boundaries between the transmissive portion TR and the non-transmissive portions NTR since diffraction of light occurs. In the example illustrated, the exposure amount is reduced as the thickness of the color resist CR is increased, in the area L. For example, the exposure amount becomes smaller toward the direction in which the color resist CR expands from the barrier films LO, for example, toward the direction of the L area. In contrast, the exposure amount becomes smaller as the thickness of the color resist CR is reduced, in the area R. For this reason, the exposure amount becomes smaller toward the direction in which the color resist CR expands from the barrier films LO, for example, toward the direction of the R area. Thus, even if the transmissive portion of the photomask PM is displaced from the first hole portion HL1, the thickness of the color resist CR is adjusted such that the color filter CF is accommodated in the first hole portion HL1 by the barrier film LO having the cross-section of a forward tapered shape.

FIG. 10C is a view showing an example of a state in which the color resist CR shown in FIG. 10B is exposed and the color filter CF is formed on the insulating film IL1. As shown in FIG. 10C, even if the transmissive portion TR of the photomask PM is displaced from the first hole portion HL1, the color filter CF is disposed substantially inside the first hole portion HL1. As explained above, the color filter CF can be formed in an exact size and located at an exact position by forming the barrier films LO.

In addition, the first hole portion HL1, the second hole portion HL2, the first protruding portion CP1, and the like are formed simultaneously by forming the barrier films LO. In other words, the positions of the first hole portion HL1, the second hole portion HL2, the first protruding portion CP1, and the like are determined and their positions are not displaced from each other by forming the barrier films LO. In other words, the positions of the color filter CF, the contact hole CH1, the first spacer portion XP1, and the like are not displaced from each other. Therefore, likelihood design assuming the displacement of the transmissive portion TR of the photomask PM from the first hole portion HL1 is unnecessary. For this reason, the color filter CF, the contact hole CH1, the first spacer portion XP1, and the like can be disposed in high density. For example, the aperture ratio can be improved by increasing an area ratio of the color filter CF (first hole portion HL1) to the display area DA.

A state of formation of the barrier films LO will be explained below. It is assumed that the barrier films LO are formed by exposing a transparent positive photoresist.

The barrier films LO are formed by, for example, forming the video signal line SG and the base layer RE on the insulating film IL1, applying the positive photoresist of a transparent organic material on the insulating film IL1, and exposing the photoresist with a halftone mask.

In general, the positive photoresist is superior to a negative photoresist with respect to processing property. For this reason, the positive photoresist can be formed to have a fine structure. In addition, the positive photoresist has photolytic property. For this reason, the positive photoresist is decomposed from a portion to which the light is applied. In other words, the thickness of the positive photoresist becomes smaller in accordance with the exposure amount. The halftone mask comprises a transmissive portion, a non-transmissive portion, and a transflective portion. The first hole portion HL1 and the second hole portion HL2 of the barrier films LO are formed by the light transmitted through the transmissive portion of the halftone mask. In addition, the portions of the barrier films LO having the upper surfaces LOA are formed by the light transmitted through the transflective portion of the halftone mask. The first protruding portions CP1 of the barrier films LO are formed by blocking the light by the non-transmissive portion of the halftone mask.

If the first protruding portions CP1 are formed of a transparent substance, the light applied from the upper side reaches the lower side, in the positive photoresist. In this case, the positive photoresist is decomposed from the upper side by photolytic property. For this reason, the barrier film LO has a cross-section of a forward tapered shape from the upper side from the lower side. If a positive photoresist having the width sufficiently large for the thickness is exposed from the upper side, the barrier film LO is formed to have a trapezoidal cross-section expanding from the upper side to the lower side. In addition, if the positive photoresist having the width equal to or smaller than the thickness is exposed from the upper side, the barrier film LO is formed to have a triangular cross-section expanding from the upper side to the lower side. If the barrier film LO is preliminarily burnt at approximately half a temperature of that in burning, before burning, the cross-section of the barrier film LO can also be maintained after burning.

For example, the thickness of the color filter CF corresponding to wide color reproduction (a large amount of the dye content) is set to approximately 2.5 μm. In this case, to dispose the color filter CF between two adjacent barrier films LO, the thickness of the barrier film LO needs to be, for example, approximately 2.0 μm. If the positive photoresist is formed in a trapezoidal shape, the widths of the upper surface and the lower surface of the cross-section of the barrier film LO are 1.5 μm and 2.5 μm, respectively. In this case, it is assumed that the thickness of the cross-section of the barrier film LO is approximately equal to the thickness (=2.0 μm) of the positive photoresist which is to be exposed. If the barrier film LO is formed such that the thickness of the cross-section is 2.0 μm and the width of the lower surface is 2.0 μm, the width of the upper surface of the cross-section of the barrier film LO is 0.7 μm. If the barrier film LO is formed such that the thickness of the cross-section is 2.0 μm and the width of the lower surface is 1.5 μm, the barrier film LO is formed to have a triangular cross-section. If the barrier film LO is formed to have a triangular cross-section, the thickness of the barrier film LO is smaller than the thickness (=2.0 μm) of the positive photoresist which is to be exposed. If the barrier film LO is a trapezoidal cross-section, tolerance of positioning the photomask PM to the upper surface of the barrier film LO is larger in the barrier film LO having a larger width of the upper surface of the cross-section. However, since the light-shielding layer BM or the common line CL is disposed above the barrier film LO, the aperture ratio of the display area DA may be smaller if the width of the upper surface of the cross-section of the barrier film LO is large. If the width of the upper surface of the cross-section of the barrier film LO is small, for example, the barrier film LO has a triangular cross-section, the aperture ratio of the display area DA may be larger. However, if the width of the upper surface of the cross-section of the barrier film LO is small, tolerance of positioning the photomask PM to the upper surface of the barrier film LO is smaller.

The color filter CF having a large dye content is formed to have an inverse tapered shape since a small amount of light reaches the lower part in the exposure. The color filter CF having a large dye content can hardly be processed since the inverse tapered shape of the cross-section collapses in burning. In the display device DSP of the present embodiment, the color filter CF having a large dye content can be accommodated in the first hole portion HL1 of the barrier film LO. In addition, even if a part of the color filter CF having a large dye content is located on the upper surface LOA of the barrier film LO, the display device DSP can be exposed to the lower part since the thickness of the color filter CF is small. Therefore, even the color filter CF having a large dye content in the display device DSP of the present embodiment can be processed with high accuracy.

According to the present embodiment, the display device comprises the grating-shaped barrier film LO on which the first hole portion HL1, the second hole portion HL2, and the like are formed. The barrier film LO is formed of, for example, a positive photoresist excellent in processing property. For this reason, the barrier film LO enables the constituent elements such as the first hole portion HL1, the second hole portion HL2 (contact hole CH1), and the first protruding portion CP1 to be formed with high accuracy, in high density. In the display device DSP, likelihood in positioning the constituent elements can be therefore made smaller. For this reason, the aperture ratio in the display area DA can be improved in the display device DSP. In addition, the color filter CF can be patterned stably by the barrier film LO, in the display device DSP. As a result, the display device DSP which enables the constituent elements to be formed with high accuracy, in high density can be provided.

Next, display devices of the other embodiments will be explained. In the other embodiments to be described below, portions similar to those of the first embodiment are denoted by the same reference numerals and detailed explanation is omitted or simplified, and portions different from those of the embodiment will be particularly explained in detail. In the other embodiments, too, the same advantages as the above-explained embodiment can be obtained.

The display device DSP of the Second Embodiment is different from that of the First Embodiment with respect to a feature that a first hole portion HL1 of a barrier film LO is different in shape from the first hole portion HL1 of the First Embodiment.

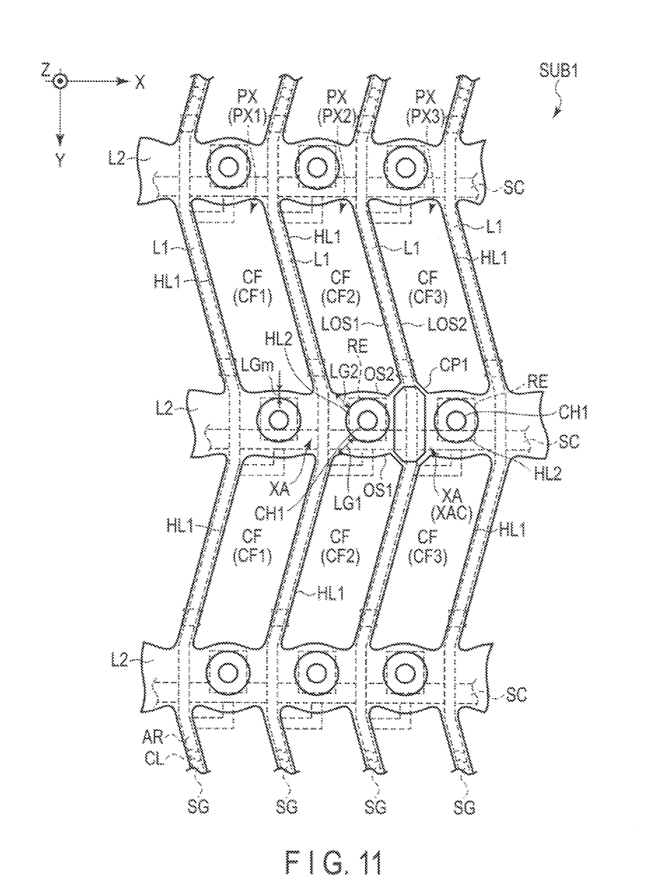

FIG. 11 is a plan view showing a barrier film LO of the first substrate SUB1 according to the Second Embodiment. FIG. 11 corresponds to FIG. 3.

A second portion L2 of the barrier film LO is narrowed along a shape of second hole portions HL2. In the example illustrated, a first side surface OS1 and a second side surface OS2 are formed to be curved along the shapes of the second hole portions HL2, in the barrier film LO. In the barrier film LO, a corner portion of the first hole portion HL1 has a curvature. In the example illustrated, the corner portions of the first hole portion HL1 protrude to the second portion L2 sides. For this reason, distance LG1 is shorter than the distance LG1 shown in FIG. 3, at the second portion L2 of the barrier film LO. Similarly, the distance is shorter than the distance LG2 shown in FIG. 3, in the barrier film LO. For example, the distance LG2 may be formed to be approximately equal to the shortest distance LGm, in the second part L2. However, the intersection XAC is formed in a shape similar to the intersection XAC shown in FIG. 3. For this reason, a corner portion of a first hole portion HL1 of the barrier film LO is depressed inwardly along a shape of a first protruding portion CP1, at intersection XAC, similarly to the barrier films LO shown in FIG. 3.

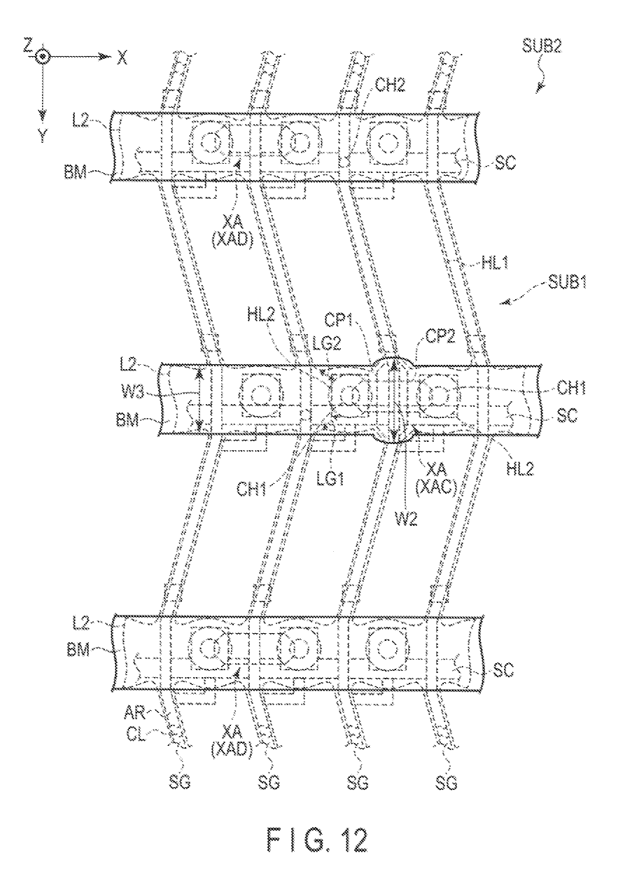

FIG. 12 is a plan view showing the second substrate SUB2 according to the Second Embodiment. FIG. 12 corresponds to FIG. 4.

In the example illustrated, the light-shielding layer BM extends in the first direction X with a width W3 along the second direction Y. The width W3 of the light-shielding layer BM is smaller than a width W1 of the light-shielding layer BM in the second direction Y shown in FIG. 3. The width of the light-shielding layer BM can be made shorter in the second direction Y, in accordance with a distance between the corner portion of the first hole portion HL1 and the second hole portion HL2, for example, the amount obtained by shortening distances LG1 and LG2. The light-shielding layer BM is expanded with a width W2 in the second direction Y, larger than the width W3, at a portion which overlaps the first protruding portion CP1.

In the Second Embodiment, too, the same advantages as those of the First Embodiment can be obtained. In addition, in the display device DSP of the Second Embodiment, the aperture ratio of each pixel PX in the display area DA can be improved since the width of the light-shielding layer BM in the second direction Y can be shortened.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A display device comprising:
a first substrate comprising a first insulating film which has a first upper surface, a first video signal line which is in contact with the first upper surface, a first barrier film which is in contact with the first upper surface, covers the first video signal line, and has a second upper surface and side surfaces, a color filter which is in contact with the first upper surface and the side surfaces and has a third upper surface, and a second insulating film which is in contact with the second upper surface and the third upper surface and has a fourth upper surface;
a second substrate opposed to the first substrate,
the fourth upper surface just above the color filter being located at an upper position than the second upper surface.

2. The display device of claim 1, wherein
the second insulating film has a first thickness just above the color filter and a second thickness at a position which overlaps the second upper surface, and the first thickness is larger than the second thickness.

3. The display device of claim 2, wherein
the color filter has a third thickness, the first barrier film as a fourth thickness, and the fourth thickness is larger than the third thickness.

4. The display device of claim 3, wherein
a sum of the first thickness and the third thickness is approximately equal to a sum of the second thickness and the fourth thickness.

5. The display device of claim 4, wherein
the first substrate comprises a first electrode which is in contact with the four upper surface, a first common line which is located above the first video signal line and the first electrode and connected to the first electrode, and a first light absorbing film which is located above the first common line.

6. The display device of claim 5, wherein
the first substrate comprises an interlayer insulating film between the first electrode and the first common line.

7. The display device of claim 6, wherein
the first barrier film and the second insulating film are formed of the same transparent organic material.

8. The display device of claim 3, wherein
the first barrier film has a tapered cross-section narrowing upwardly.

9. The display device of claim 1, wherein
the first substrates further comprises, in planar view, a first scanning signal line which extends in a first direction, a second scanning signal line which is separated in a second direction intersecting the first direction and extends in the first direction, a second barrier film which intersects the first barrier film, a third barrier film which is separated from the first barrier film in the first direction and intersects the second barrier film, and a fourth barrier film which is separated from the second barrier film in the second direction and intersects the first barrier film and the third barrier film,
the second barrier film extends along the first scanning signal line,
the fourth barrier film extends along the second scanning signal line, and
the first barrier film, the second barrier film, the third barrier film, and the fourth barrier film are provided in a grating shape.

10. The display device of claim 9, wherein
the first substrate comprises a first protruding portion which protrudes more upwardly than the second upper surface, at a position where the first barrier film and the second barrier film intersect,
the second substrate comprises a second protruding portion which protrudes downwardly at a position opposed to the first protruding portion, and
the first protruding portion and the second protruding portion intersect in planar view.

11. A display device comprising:
a first substrate comprising a first insulating film which has a first upper surface, a first base which is in contact with the first upper surface, a second base which is in contact with the first upper surface and separated from the first base, a video signal line which is in contact with the first upper surface, located between the first base and the second base, and electrically connected to the second base,
a barrier film which is in contact with the first upper surface, covers the video signal line, the first base, and the second base, includes a first contact hole formed to penetrate to the first base, includes a second contact hole formed to penetrate to the second base, and has a first side surface and a second side surface, a first color filter which is in contact with the first side surface, and a second color filter which is in contact with the second side surface and has a color different from the color of the first color filter; and
a second substrate opposed to the first substrate,
the barrier film having a second upper surface between the first color filter and the second color filter, and having a first protruding portion which protrudes more upwardly than the second upper surface between the first contact hole and the second contact hole.

12. The display device of claim 11, wherein
the first substrate comprises a second insulating film which is located above the first color filter, the second color filter, and the barrier film, a first electrode which is located above the second insulating film, a common line which is located above the video signal line and the first electrode and which is connected to the first electrode, and a light absorbing film which is located above the common line.

13. The display device of claim 12, wherein
the first substrate comprises an interlayer insulating film between the first electrode and the common line, a third contact hole which penetrates to the first electrode is formed in the interlayer insulating film, and the common line is electrically connected to the first electrode through the third contact hole.

14. The display device of claim 13, wherein
the first substrate comprises a first scanning line and a second scanning line which intersect the video signal line,
the third contact hole is located at an intersection of the first scanning line and the video signal line, and
the first protruding portion is located at an intersection of the second scanning line and the video signal line.

15. The display device of claim 14, wherein
the second substrate comprises a second protruding portion which protrudes downwardly at a position opposed to the first protruding portion, and
the first protruding portion and the second protruding portion intersect in planar view.

16. The display device of claim 15, wherein
the barrier film is narrowed along a shape of the first contact hole in planar view.

17. A display device comprising:
a first substrate comprising a first insulating film which has a first upper surface, a video signal line which is in contact with the first upper surface, a barrier film which is in contact with the first upper surface and covers the video signal line, a color filter which is in contact with the first upper surface, a second insulating film which is in contact with the barrier film and the color filter, a first electrode which is located above the second insulating film, a common line which is located above the video signal line and the first electrode and which is in contact with the first electrode, and a light absorbing film which is located above the common line; and
a second substrate opposed to the first substrate.

18. The display device of claim 17, wherein
the first substrate comprises a first protruding portion which protrudes more upwardly than the barrier film,
the second substrate comprises a second protruding portion which protrudes downwardly at a position opposed to the first protruding portion, and
the first protruding portion and the second protruding portion intersect in planar view.

19. The display device of claim 18, wherein
the second insulating film, the first electrode, the common line, and the light absorbing film are located between the first protruding portion and the second protruding portion.
